(19) United States
(12) Patent Application Publication
(10) Pub. No.: US 2023/0211662 A1
(43) Pub. Date: Jul. 6, 2023

(54) Control of Display Areas

(71) Applicant: Bayerische Motoren Werke Aktiengesellschaft, Muenchen (DE)

(72) Inventors: Bjoern BERTRAND, Muenchen (DE); Adrian VAN HOOYDONK, Muenchen (DE)

(21) Appl. No.: 18/008,493

(22) PCT Filed: Jun. 22, 2021
(86) PCT No.: PCT/DE2021/100530

§ 371 Date: Dec. 6, 2022

(30) Foreign Application Priority Data
Jul. 24, 2020 (DE) 10 2020 119 640.7

(51) Int. Cl. B60K 35/00

(52) U.S. Cl. CPC B60K 35/00; B60K 2370/113; B60K 2370/115; B60K 2370/12; B60K 2370/1529; B60K 2370/52

(57) ABSTRACT

A method for providing content in various display areas of at least one display includes the steps of acquiring a first selection of one of the display areas; acquiring a second selection of an element of a list that is associated with the selected display area; and providing in the selected display area a content that is associated with the selected element.

### BACKGROUND AND SUMMARY

The invention relates to the control of display areas on one or more displays. In particular, the invention relates to providing contents on different display areas of a display on board a vehicle.

A vehicle comprises one or more control units, which can each output items of information on an optical display. Sometimes, multiple control units have to share a display, wherein one display area of the display can be assigned to each control unit. Multiple displays can also be provided, which each comprise one or more display areas, which are each available for displaying items of information of a control unit. One display can be provided, for example, in the field of view of a driver and another can be provided to be viewed by a passenger in the backseat of the vehicle.

A person on board the vehicle can configure which contents he wishes to see on which display or on which display area. This configuration can be changed if needed. For example, a displayed content of a navigation system can be removed from a display area and a content of an entertainment system can be output on this display area.

A configuration of which content is output on which display area can be difficult to set for the person. In particular, if the person is a driver, the configuration is intended to be carried out easily and intuitively. The driver is to be distracted as little as possible by the configuration and is to be able to direct his attention as completely as possible to driving the vehicle.

The present invention is based on the object of providing an improved control of display areas of one or more displays, in particular on board a vehicle. The invention achieves the object by means of the subjects of the independent claims. Dependent claims reflect preferred embodiments.

According to a first aspect of the present invention, a method for providing contents on various display areas of at least one display comprises steps of acquiring a first selection of one of the display areas; acquiring a second selection of an element of a list which is assigned to the selected display area; and providing a content which is assigned to the selected element on the selected display area.

A list in the present context comprises a collection of elements in a predetermined sequence, so that a following element is assigned to each element except for a last element and a preceding element is assigned to each element except for a first element. A function or a setting is typically assigned to an element. A user can graphically select the element on the display area and trigger the function or change the setting.

According to the invention, a person can make a first and a second selection in a simple manner to control the display of a desired content on a predetermined display area. The selection of the desired content can take place rapidly, intuitively, precisely, or without distraction. A change of a displayed content can only affect the selected display area, other display areas can be untouched by the change.

By the assignment of a predetermined list of elements to a display area, the second selection can be restricted in such a way that an assignment of a content to a display area which is unfortunate, unskilled, or undesired for legal reasons, for example, can be prevented. If the method is executed on board a vehicle, for example, it is thus possible to prevent a video data stream of an entertainment system from being displayed to a driver of the vehicle on a head-up display (HUD). In a similar manner, it is possible to prevent a driving speed of the vehicle, the display of which always has to take place for the driver for legal reasons, from being switched off or redirected to a display not visible to the driver.

It is particularly preferred for the list to be cyclic. If a switch forward is made in a cyclic list from a next-to-last element two steps in the direction of the last element, the first element can thus be selected. It is possible to move accordingly in the reverse direction. An element of the cyclic list can thus be selected quickly and easily. In particular if the selection of the element is carried out by incrementally switching forward between adjacent elements of the list, the switching over from a first to a second element can take place with fewer inputs and can be carried out faster.

It is additionally preferred for the lists to be arranged in a predetermined sequence, wherein it is possible to switch over from one list to an adjacent list incrementally, thus in steps of 1 or −1. A sequence of lists can also be cyclic here. It is thus possible to switch over quickly and easily between lists or the display areas assigned to them.

In one embodiment, an overview of the selected list is displayed on a display area of the at least one display. The display area on which the overview is displayed can be available exclusively for this purpose or can be available for displaying contents which are assigned to an element of a list. In one embodiment, the display area can be overlaid dynamically. For example, the overview can be displayed graphically floating over one or more display areas. The overview can be partially transparent so that a content of a display area located behind it can still be recognizable to a user. The overview can orient about which element of a list is selected.

The overview can comprise a representation of the selected element and of at least one adjacent element of the selected list. A predetermined number of adjacent elements is preferably displayed in both directions of the list. Finding an intended element of the list can thus be facilitated.

In a further embodiment, the representation of an element can comprise a miniature of the content assigned to the element. The content can also be displayed in simplified or stylized form here. In a further embodiment, instead of the miniature, a symbol for the selected content can be displayed, for example, a pictogram. An identification or recognition of an element can thus be facilitated for a user.

In still a further embodiment, the overview comprises a display of the selected list and of at least one adjacent list. In this case, the lists are organized in a predetermined sequence, so that it is possible to switch over sequentially between the lists. The sequence is furthermore preferably cyclic. One or more adjacent lists can also be displayed here in each direction.

It is generally preferred that a selected list or a selected element is displayed larger than an adjacent, non-selected list or an adjacent, non-selected element. A size of a displayed list or of a displayed element can decrease further with increasing distance from the selected list or the selected element, respectively.

In another embodiment, in which an overview is not displayed, a selected display area can be graphically highlighted, for example, by a frame, a gloss, an aura, a brightening or darkening, or a change of a color palette.

According to a second aspect of the present invention, a control device for providing contents on various display areas comprises at least one display, an input device for acquiring a first and a second selection, wherein the first selection selects one of the display areas and the second selection selects an element of a list which is assigned to the selected display area. In addition, a processing unit is provided, which is configured to provide a content which is assigned to a selected element on the selected display area.

The control device and in particular the processing unit can be configured to entirely or partially execute a method described herein. For this purpose, the processing unit can comprise a programmable microcomputer or microcontroller and the method can be provided in the form of a computer program product having program code means. The computer program product can be stored on a computer-readable data carrier. Features or advantages of the method can be transferred to the device or vice versa.

In a further embodiment, multiple displays are provided, wherein one of the displays can comprise a head-up display. The control device can be used here in particular on board a vehicle. A further display can be provided, for example, in the area of a center console, in the field of view of a driver, or that of a front passenger. Displayed contents on board the vehicle can be adjusted easily to currently applicable request of one or more persons located on board the vehicle.

The input device can comprise a four-way element, wherein two ways are assigned to each of the selections, which are preferably arranged located opposite to one another. The four-way element can comprise, for example, a four-way switch or corresponding buttons. The input by means of a touch-sensitive surface (trackpad, touchpad) is also possible. For example, two actuations located opposite to one another can control an incremental change of the selected list or the selected display area, while two other actuations located opposite to one another can control an incremental change of a selected element of the selected list. In one particularly preferred embodiment, the lists or display areas are switched over by means of horizontally oriented actuations and the elements within one list are switched over by means of vertically oriented actuations. A reverse assignment is also possible.

A selection of one of the elements can result in the immediate display of a predetermined content on the selected display area. In a further embodiment, a further actuation of a predetermined operating element for confirming the second selection is additionally provided before an effect unfolds on the selected display area. Whether a confirmation is required can be assigned to the content. For example, in a navigation system the change of a magnification level can be implemented immediately, in that a map is displayed in the selected display area in a presently selected scale, while the selection of a function for setting the navigation destination can only be accepted after input of a confirmation.

The input device can be attached in particular to the steering wheel of a vehicle. In other embodiments, the input device can also be attached to another operating element of a vehicle, for example, to a selection lever for a gear level or in the area of a central control and input element.

According to a further aspect of the present invention, a system comprises a control device described herein and at least one display. Multiple display areas are provided here on the at least one display.

According to still a further aspect of the present invention, a vehicle comprises a control device described herein or a system described herein.

The invention will now be described in more detail with reference to the appended drawings.

### BRIEF DESCRIPTION OF THE DRAWINGS

FIG. 1 illustrates a vehicle having a system;

FIG. 2 illustrates a flow chart of a method;

FIG. 3 illustrates an exemplary organization of contents for display areas; and

FIG. 4 illustrates an overview of selections of a list and an element.

### DETAILED DESCRIPTION OF THE DRAWINGS

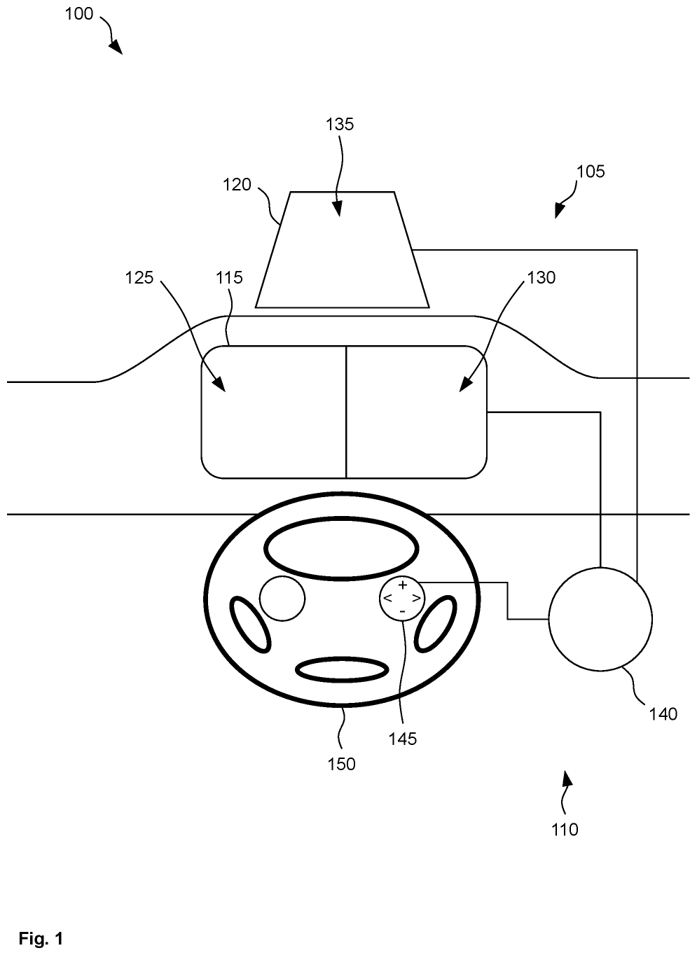

FIG. 1 shows a schematic illustration of an exemplary vehicle 100 having a system 105. The vehicle 100 preferably comprises a motor vehicle, in particular a passenger vehicle, a motorcycle, a truck, or a bus. The illustrated system 105 comprises a control device 110 and a first display 115 and preferably a second display 120. The displays 115, 120 are each configured to be read by a person on board the vehicle 100. In the illustrated embodiment, both displays 115, 120 are directed toward a driver of the vehicle 100. The first display 115 is embodied, for example, as a multifunction display on a dashboard. The second display 120 is embodied as a head-up display, so that the driver can visually perceive a content displayed on the second display 120, but at the same time can look through the second display 120 into the surroundings of the vehicle 100.

At least one display area is defined on each of the displays 115, 120. In the present case, a first display area 125 and a second display area 130 are defined on the first display 115, while a third display area 135 is defined on the second display 120. It is to be noted that in other embodiments the display areas 125-135 can also be defined on only one or on more than two displays 115, 120. The present invention preferably presumes at least two display areas 125-135, which can be located on one or more displays 115, 120.

The control device 110 is configured to control the displays 115 and 120. For this purpose, contents to be displayed respectively on the display areas 125 to 135 can be output in particular, for example, in the form of text or a graphic. The control device 110 preferably comprises a processing unit 140 and an input device 145, which is arranged by way of example on a steering wheel 150 of the vehicle 100. The input device 145 is configured to be actuated by a user in order to make at least two selections independent of one another. In the illustrated embodiment, the input device 145 comprises for this purpose a four-way button, which can be actuated upward, downward, right, and left. In addition, an actuation in the center can take place in the meaning of a confirmation. Instead of buttons, for example, a touch-sensitive surface can also be used to recognize a gesture.

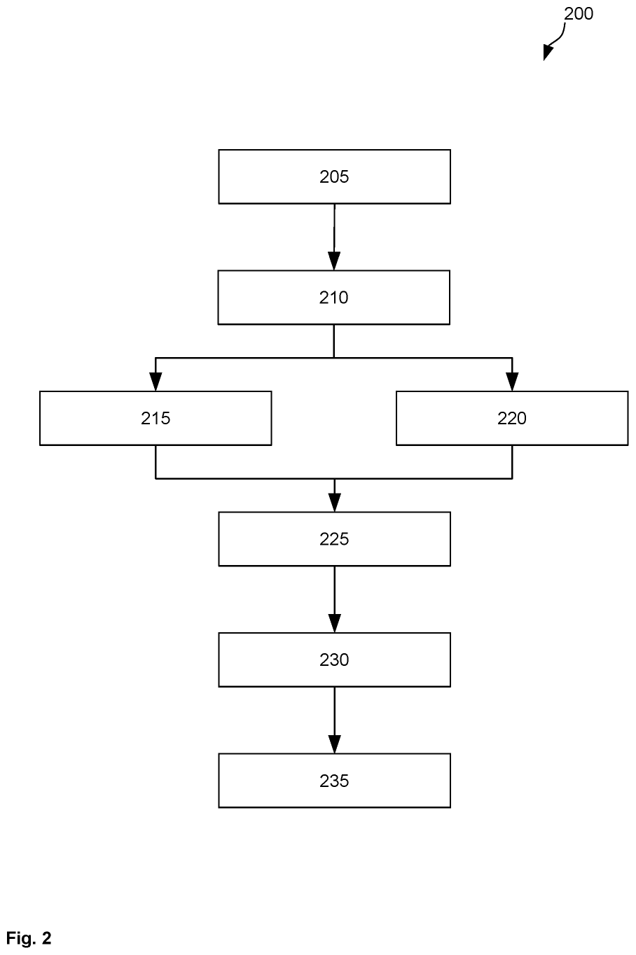

FIG. 2 shows a flow chart of a method 200 for controlling the provision of contents on different display areas 125 to 135. The method 200 can be carried out in particular in conjunction with a system 105.

In a step 205, the input unit 145 can be scanned. If an input is recognized, for example, the input of a confirmation, it is thus possible to begin with changing an output of contents on the display areas 125 to 135.

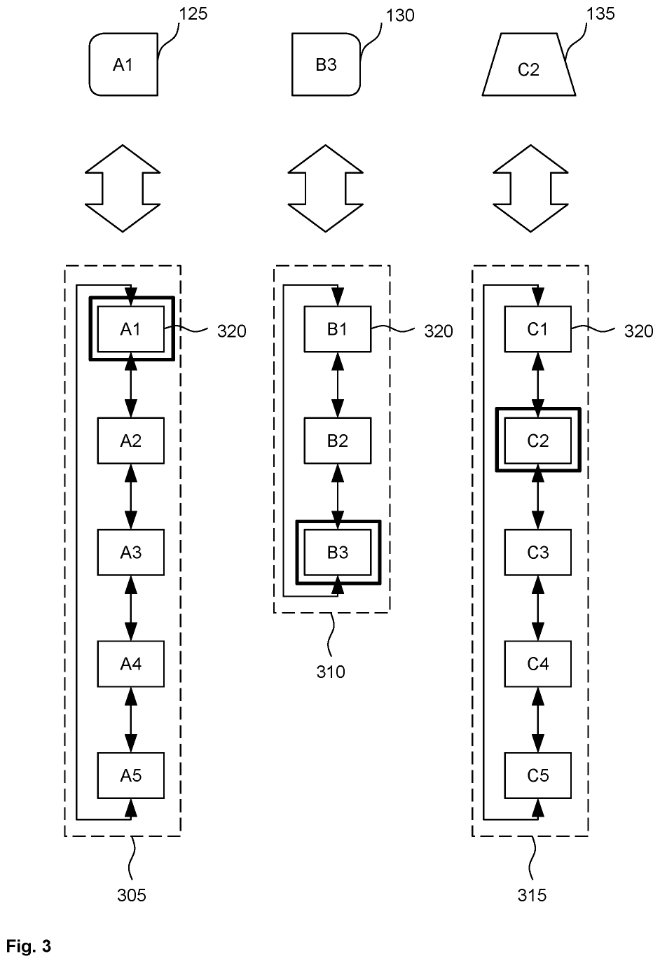

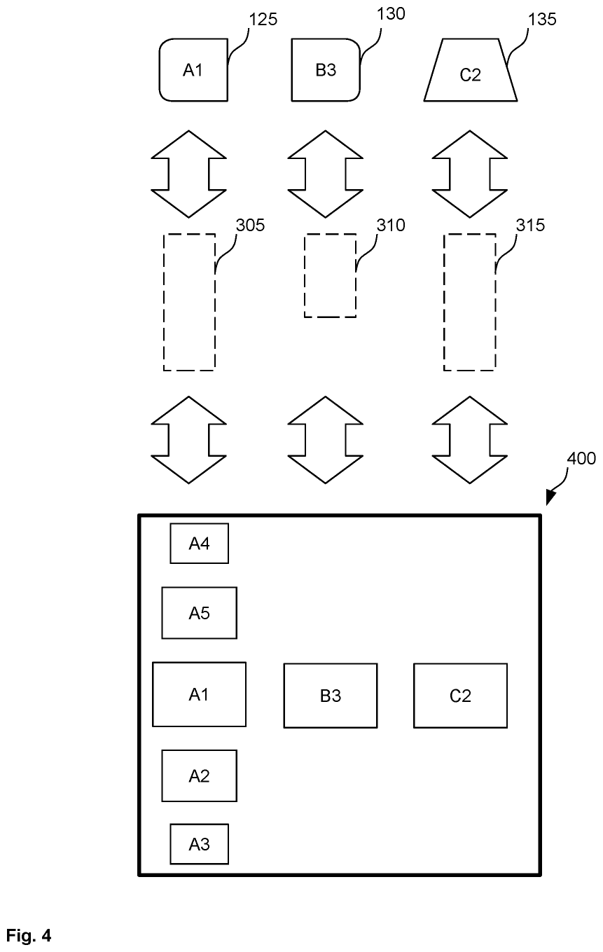

In a step 210, an overview can be overlaid on one of the display areas 125 to 135 or a further, dedicated display area, which is explained in more detail hereinafter with reference to FIGS. 3 and 4. The overview can also be called “navigator” and comprises a graphic interaction element to enable a user the determination of selections. It is to be noted that an effect of a selection of an element shown on the overview can relate to a different display area 125 to 135 than the one on which the overview itself is shown.

In a step 215, one of the display areas 125 to 135 can be selected, to which a different content to be displayed is to be assigned. The selection can be assisted by the overview in that, for example, it is indicated which display areas 125 to 135 are present and which is presently selected.

A display area 125 to 135 is assigned a list having elements which is described in more detail hereinafter with reference to FIG. 3. A predetermined content to be displayed is assigned to each element. On the selected display areas 125 to 135, the content is always output which is assigned to the selected element of the list assigned to the display area 125 to 135. In a step 220, an element of a list can be selected which is assigned to the selected display area 125 to 135. For this purpose, a selection of the element can be shifted step by step along the list. This selection can also be assisted by the overview, for example, in that textual or iconographic indications are shown on possible elements. A selected element can be highlighted. Steps 215 and 220 are shown concurrently to symbolize that the display area 125 to 135 and the content to be displayed on the selected display area 125 to 135 can also be selected or changed multiple times in arbitrary sequence and as needed.

In a step 225, the two relevant selections can be accepted. This can take place in particular when the actuation of a confirmation has been acquired at the input unit 145.

In a step 230, the selected content can be displayed on the selected display area 125 to 135. A predetermined content can thus be respectively assigned to each display area 125 to 135, which can then be displayed. It is to be noted that respectively contents to be displayed can also be controlled or changed for multiple display areas 125 to 135 in steps 215 and 220.

In a step 235, the overview can be hidden if it has previously been shown in step 210. The system 105 can thus be put into a typical operating state. For the renewed change of displayed contents on the display areas 125 to 135, it is possible to run through the method 200 again.

FIG. 3 shows an exemplary organization of contents for display areas 125 to 135. In the system 105, each available display area 125 to 135 is assigned a list which contains elements of which one can be selected. The first display area 125 is assigned, for example, a first list 305, the second display area 130 is assigned a second list 310, and the third display area 135 is assigned a third list 315. Each list 305 to 315 comprises a number of elements 320. The first list 305 comprises elements 320 which are designated as A1 to A5, wherein the first list 305 can also be called list A. The second list 310 comprises elements 320 B1 to B3 and can also be called list B. The third list 315 comprises elements 320 C1 to C5 and can also be called list C.

Each element 320 stands for a respectively individually assigned content. Which content is displayed on a display area 125 to 135 is dependent on which of the elements 320 of the list 305 to 315 assigned to the display area 125 to 135 is selected. In the illustrated embodiment, the elements A1, B3, and C2 are selected, so that on the first display area 125, the content is output which is assigned to the element 320 A1, on the second display area 130 the content is output which is assigned to the element 320 B3, and on the third display area 135 the content is output which is assigned to the element 320 C2.

FIG. 4 shows an overview 400 of selections of a list 305 to 315 and of an element 320. The overview 400 can be shown to a user while this user selects an element 320 for a display area 125 to 135. In the overview 400, each element 320 can be visually represented by a text, a symbol, or a miniaturized representation of a content, which is assigned to the respective element 320. The procedure described with respect to the overview 400 relates in particular to steps 215 and 220 of the method 200 and can also be applied without the overview 400 actually being shown to a user.

A user can make two selections to assign a content to a display area 125 to 135. A first selection relates to a display area 125 to 135 or a list 305 to 315 assigned to the respective display area 125 to 135. In the embodiment shown in FIG. 4, the first display area 125 or the first list 305 is selected. The lists 305 to 315 are arranged in a predetermined sequence, which is preferably cyclic, so that a first and a last element 320 of the list 305 to 315 are adjacent to one another. The selection made of the first list 305 can thus be changed, for example, by an actuation of the input element 145 to the right to the second list 310, from there by a further actuation to the right to the third list 315, and if needed by still a further actuation to the right to the first list 305. In a corresponding manner, the selected list 305 to 315 can also be changed by an actuation of the input element 145 to the left in the reverse sequence.

In one embodiment, the lists 305 to 315 are hierarchically organized. For example, an element 320 can be selected in the first list 305, to which the second list 310 is assigned. Another element 320 of the first list 305 could be assigned another second list 310. After selection of the element 320 of the first list 305, an element 320 of the second list 310 can be selected which can be assigned to either a function or a third list 315. Arbitrarily many hierarchy levels can thus be managed.

In the illustrated embodiment, it is shown for each list 305 to 315 which element 320 is presently selected. Only for the first list 305 selected as an example, it is additionally possible to show which elements 320 are available for a second selection. A change of the selected element 320 can take place incrementally, thus by transition from a selected element 320 to an adjacent element 320, wherein preferably the list 305 is cyclic, so that the two elements A1 and A5 at opposite ends of the first list 305 are also adjacent to one another. For each direction of an incremental change of the selected element 320, a predetermined display of incrementally adjacent elements 320 can be displayed. In the illustrated embodiment, two adjacent elements 320 are respectively shown at the top and bottom. The size of a displayed, non-selected element 320 can decrease with the distance from the selected element 320 here. Overall, the visual impression of a wheel can thus result, on the outside of which designations or symbols for the elements 320 are attached and which is rotatably mounted around a horizontal axis of rotation.

Proceeding from the illustration of FIG. 4, a user could change the selected element 320 of the first list 305 from A1 to A5, for example, by actuating the input device 145 upward. This change can become effective immediately or only after a confirmation. Subsequently, by actuating the input device 145 to the right, he could select the second list 310 and select the element 320 B2 by an actuation upward. He could use a similar procedure with respect to the third list 315.

The changing of the selected element 320 within one of the lists 305 to 315 and/or the changing of the selected list 305 to 315 can also be controlled in a further embodiment in that the overview 400 is displayed on a touch-sensitive display 115, 120 (touchscreen) and a user touches this and carries out, for example, a horizontal or vertical gesture or actuation.

### LIST OF REFERENCE NUMERALS

100 vehicle
105 system
110 control device
115 first display (multifunction display)
120 second display (head-up display)
125 first display area
130 second display area
135 third display area
140 processing unit
145 input device
150 steering wheel
200 method
205 scan input unit
210 overlay overview
215 select display area
220 select element from list
225 accept selection
230 display content
235 hide overview
305 first list (list A)
310 second list (list B)
315 third list (list C)
320 element
400 overview

1.-12. (canceled)

13. A method for providing contents on various display areas of at least one display, the method comprising the steps of:
acquiring a first selection of one of the display areas;
acquiring a second selection of an element of a list, which is assigned to the selected display area; and
providing content, which is assigned to the selected element, on the selected display area.

14. The method according to claim 13, wherein the list is cyclic.

15. The method according to claim 13, wherein
an overview of the selected list is shown on a display area of the at least one display.

16. The method according to claim 15, wherein
the overview comprises a representation of the selected element and at least one adjacent element of the selected list.

17. The method according to claim 16, wherein
the representation of an element comprises a miniature of the content assigned to the selected element.

18. The method according to claim 15, wherein
the overview comprises a representation of the selected list and at least one adjacent list.

19. A control device for providing contents on various display areas of at least one display, wherein the control device comprises:
an input device for acquiring a first and a second selection;
wherein the first selection selects one of the display areas and the second selection selects an element of a list, which is assigned to the selected display area; and
a processing unit, which is configured to provide content which is assigned to the selected element on the selected display area.

20. The control device according to claim 19, wherein
multiple displays are provided and one of the displays comprises a head-up display.

21. The control device according to claim 19, wherein
the input device comprises a four-way element and two ways are assigned to each of the first and second selections.

22. The control device according to claim 21, wherein
the input device is attached to a steering wheel of a vehicle.

23. A system, comprising:
a control device according to claim 19; and
at least one display, wherein multiple display areas are provided on the at least one display.

24. A vehicle comprising a control device according to claim 19.
